(19) United States
(12) Patent Application Publication
(10) Pub. No.: US 2015/0372797 A1
(43) Pub. Date: Dec. 24, 2015

(54) BASE STATION AND TERMINAL

(71) Applicant: FUJITSU LIMITED, Kawasaki-shi (JP)

(72) Inventors: Shunsuke FUJIO, Kawasaki (JP); Dai KIMURA, Yokohama (JP)

(21) Appl. No.: 14/718,611

(22) Filed: May 21, 2015

(30) Foreign Application Priority Data
Jun. 23, 2014 (JP) 2014-128583

(51) Int. Cl. H04L 5/14; H04W 72/04

(52) U.S. Cl. CPC H04L 5/14; H04W 72/0446; H04W 72/0413; H04W 72/042; H04W 88/08

(57) ABSTRACT

A base station including: a memory, and a processor coupled to the memory and configured to: transmit a radio signal using a plurality of antennas in a first period for transmission of the base station in a time division duplex (TDD) mode, at least a part of the first period overlapping with at least a part of a second period for reception of another base station in the TDD mode, receive a specific information from the another base station, the first information indicating a channel characteristic from the base station to the another base station, the channel characteristic being estimated in accordance with the transmitted radio signal, and determine at least one correction coefficient to compensate for a difference of specific characteristics among the plurality of antennas based on the received specific information.

### CROSS-REFERENCE TO RELATED APPLICATION

This application is based upon and claims the benefit of priority from the prior Japanese Patent Application No. 2014-128583 filed on Jun. 23, 2014, the entire contents of which are incorporated herein by reference.

### FIELD

The embodiments discussed herein are related to a base station device, a communication system, and a terminal device.

### BACKGROUND

In cellular communications in which a wireless base station having plural antennas and a wireless terminal perform communications, the base station forms a proper transmit beam according to a channel of downlink (DL) and performs DL transmission, which can achieve an improvement in the throughput. At this time, in a time division duplex (TDD) system, in which uplink (UL) and the DL are switched in a time-division manner, the same frequency is used between the UL and the DL and thus reversibility of the channel between antennas of the base station and the terminal can be utilized. If the channels completely correspond with each other between the UL and the DL, a transmit beam of the DL can be formed by utilizing a channel estimated by the base station with an UL signal. Therefore, the transmit beamforming can be carried out without feedback of DL channel information from the terminal.

However, in practice, the reversibility does not necessarily hold regarding the channel observed in a digital section attributed to a characteristic difference between transmitting and receiving analog circuits of the base station and a characteristic difference between transmitting and receiving analog circuits of the terminal. Therefore, calibration to compensate for the characteristic difference between the analog circuits is performed.

As a method of this calibration, there is a method in which an analog circuit exclusively for the calibration is provided to make characteristics correspond with each other between transmission and reception for example. However, providing the circuit exclusively for the calibration leads to increase in the cost and therefore is undesirable.

On the other hand, as a method in which an analog circuit exclusively for the calibration is not provided, there is a method in which calibration is performed by utilizing channel information between a base station and a terminal. For example, the base station obtains an UL channel estimate from an UL signal from the terminal. Furthermore, the terminal obtains a DL channel estimate from a DL signal from the base station. Then, on the basis of the UL channel estimate and the DL channel estimate fed back from the terminal, the base station corrects the UL channel estimate so that the characteristic difference between transmitting and receiving analog circuits of each antenna of the base station may correspond with the characteristic difference of any antenna. The influence of the characteristic difference between the analog circuits on the terminal side is influence common to all antennas of the base station. Thus, even with calibration in which only the base station is taken into consideration, a beam can be correctly formed. Therefore, in this method, the correction is carried out by taking into consideration only the characteristic difference between the analog circuits of the base station without taking into consideration the characteristic difference between the analog circuits of the terminal.

### PRIOR ART DOCUMENT

### Patent Document

[Patent Document 1] Japanese Laid-open Patent Publication No. 2010-219746

### SUMMARY

According to an aspect of the invention, a base station includes a memory, and a processor coupled to the memory and configured to: transmit a radio signal using a plurality of antennas in a first period for transmission of the base station in a time division duplex (TDD) mode, at least a part of the first period overlapping with at least a part of a second period for reception of another base station in the TDD mode, receive a specific information from the another base station, the first information indicating a channel characteristic from the base station to the another base station, the channel characteristic being estimated in accordance with the transmitted radio signal, and determine at least one correction coefficient to compensate for a difference of specific characteristics among the plurality of antennas based on the received specific information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining one example of a system configuration;

FIG. 2 is a diagram illustrating one example of a DL/UL configuration of 3GPP;

FIG. 3 is a diagram for explaining a characteristic difference between a transmitting system and a receiving system;

FIG. 4 is a diagram illustrating a schematic configuration of a base station;

FIG. 5 is a diagram illustrating one example of a setting of a DL/UL configuration;

FIG. 6 is a sequence diagram illustrating one example of a flow of calibration;

FIG. 7 is a flowchart illustrating one example of a procedure of calibration processing;

FIG. 8 is a diagram illustrating one example of a data configuration of a special subframe;

FIG. 9 is a diagram illustrating one example of a setting of a DL/UL configuration;

FIG. 10 is a sequence diagram illustrating one example of a flow of calibration;

FIG. 11 is a flowchart illustrating one example of a procedure of calibration processing;

FIG. 12 is a diagram for explaining one example of a system configuration;

FIG. 13 is a diagram illustrating one example of a setting of a DL/UL configuration;

FIG. 14 is a sequence diagram illustrating one example of a flow of calibration;

FIG. 15 is a diagram for explaining one example of a system configuration; and

FIG. 16 is a diagram illustrating a computer that executes a calibration program.

### DESCRIPTION OF EMBODIMENTS

However, in communications between a base station and a terminal, it is difficult to perform calibration with high accuracy in some cases. For example, if a terminal with high reception quality does not exist in a cell, it is difficult to accurately carry out a channel estimation and therefore it is difficult to perform the calibration with high accuracy. Furthermore, if the terminal is moving, a channel greatly varies between a DL channel estimation and a UL channel estimation and it is difficult to perform the calibration with high accuracy.

Techniques disclosed in the present application intend to provide a base station device, a communication system, and a terminal device that can accurately perform calibration.

Embodiment examples of the base station device, the communication system, and the terminal device disclosed in the present application will be described in detail below on the basis of the drawings. Note that following embodiment examples shall not limit the techniques of the disclosure. Furthermore, the respective embodiment examples can be combined as appropriate within such a range as not to cause inconsistency of contents of processing.

### Embodiment Example 1

### Configuration of System

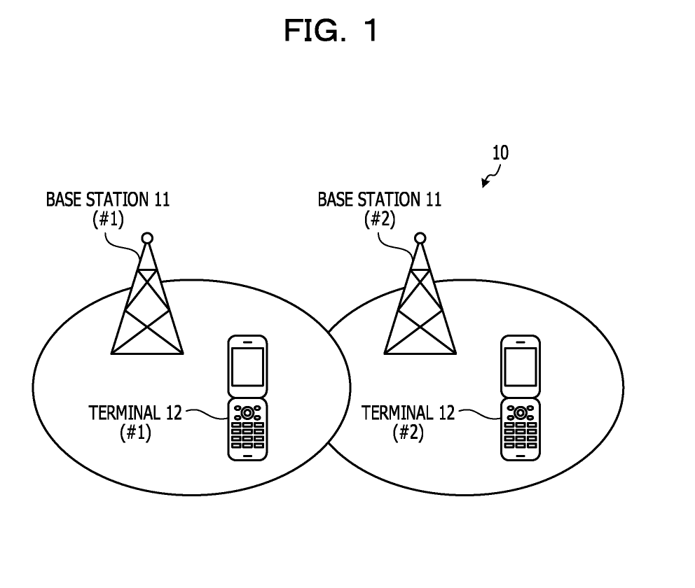

To begin with, one example of a system according to embodiment example 1 will be described. FIG. 1 is a diagram for explaining one example of a system configuration. A system 10 is a communication system that carries out communications by a cellular system. As illustrated in FIG. 1, the system 10 has base stations 11 and terminals 12. In the example of FIG. 1, a case in which the number of base stations 11 is two is exemplified. However, the number of base stations 11 is not limited thereto and can be set to an arbitrary number. Furthermore, in the example of FIG. 1, a case in which the number of terminals 12 is two is exemplified. However, the number of terminals 12 is also not limited thereto and can be set to an arbitrary number. Each base station 11 is allowed to wirelessly communicate with the terminal 12 in a communication area. In the example of FIG. 1, the communication areas of the respective base stations 11 are each represented by an ellipse and each one terminal 12 is represented in the communication area of the base station 11. The base station 11 communicates with the terminal 12 in the communication area by a TDD system with use of the same frequency. The base station 11 is provided with plural antennas and forms a proper transmit beam to perform DL transmission by using the respective antennas.

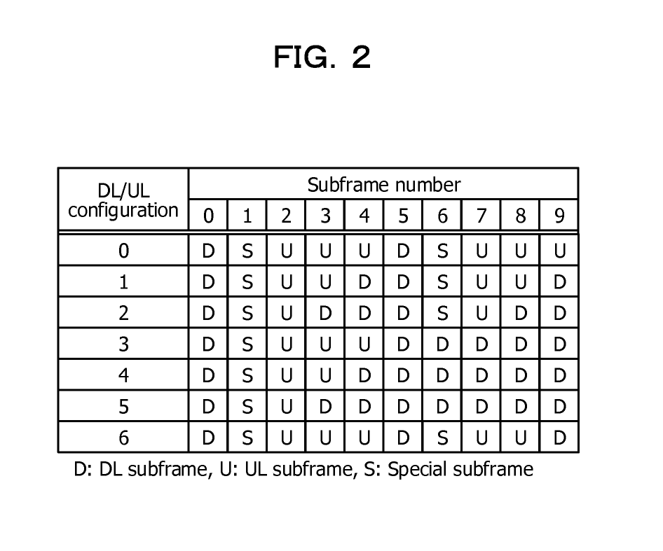

In the TDD system, timings of UL and DL are synchronized between the base station 11 and the terminal 12 in order to perform UL transmission and DL transmission in a time-division manner by using the same frequency. For example, in 3rd generation partnership project (3GPP), the timings of the UL and the DL are synchronized by using a DL/UL configuration. FIG. 2 is a diagram illustrating one example of a DL/UL configuration of 3GPP. In FIG. 2, seven DL/UL configurations of 0 to 6 are represented. Hereinafter, in the case of individually indicating each of the DL/UL configurations of 0 to 6, the DL/UL configuration will be so represented as to be given a respective one of numbers #0 to #6.

In the DL/UL configuration, one frame is divided into ten subframes of 0 to 9 and setting communications in a period of the subframe on each subframe basis is allowed. Hereinafter, in the case of individually indicating each of the subframes of 0 to 9, the subframe will be so represented as to be given a respective one of numbers #0 to #9. One frame is e.g. a period of ten milliseconds. The subframe is e.g. a period of one millisecond. “D” described in the subframe denotes a subframe of DL. “U” denotes a subframe of UL. “S” denotes a special subframe. The special subframe is set at the timing of switching from DL to UL. In the TDD system, the terminal 12 receives a DL signal by a receiving circuit and thereafter switches the circuit to a transmitting circuit to carry out UL transmission. The special subframe is set corresponding to propagation delay until an UL signal from the terminal 12 reaches the base station 11 after the base station 11 transmits a DL signal.

As illustrated in FIG. 2, DL/UL configurations #0 to #6 are different in the subframe rate between DL and UL. The base station 11 notifies the terminal 12 in the communication area of the DL/UL configuration used in communications, and the base station 11 and the terminal 12 in the communication area perform UL or DL in accordance with the setting of the subframe in the period of each subframe set in the DL/UL configuration.

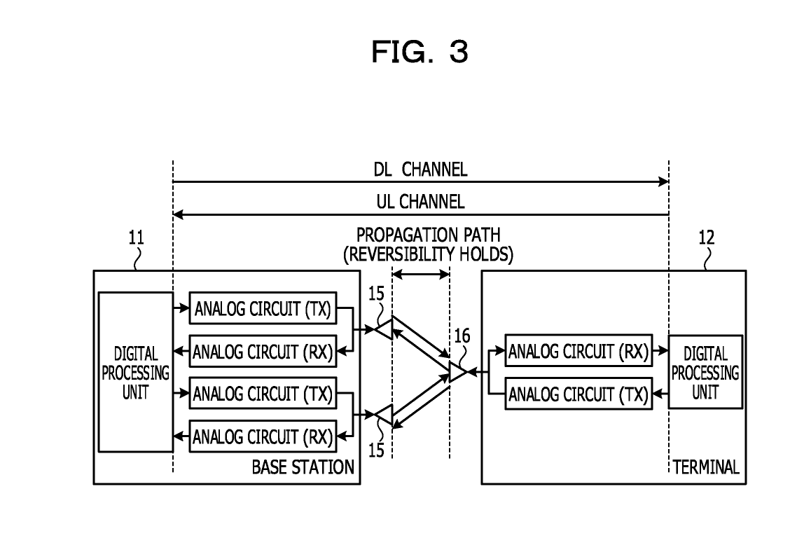

In the base station 11 and the terminal 12, an analog circuit is partly separated between the transmitting system and the receiving system and there is a difference in the characteristics of the analog circuit between the transmitting system and the receiving system. FIG. 3 is a diagram for explaining a characteristic difference between a transmitting system and a receiving system. The base station 11 is provided with plural antennas 15 and an analog circuit (TX) of the transmitting system and an analog circuit (RX) of the receiving system are coupled to each antenna 15. Also regarding the terminal 12, the analog circuit (TX) of the transmitting system and the analog circuit (RX) of the receiving system are coupled to an antenna 16. In DL, a signal flows from a digital processing unit and the analog circuit (TX) of the base station 11 to the analog circuit (RX) and a digital processing unit of the terminal 12 via a propagation path. In UL, a signal flows from the digital processing unit and the analog circuit (TX) of the terminal 12 to the analog circuit (RX) and the digital processing unit of the base station 11 via the propagation path. The propagation path has the same characteristics between the UL and the DL. On the other hand, because the analog circuit through which the signal passes is different between the transmitting system and the receiving system, characteristics are different between the UL and the DL. The influence of the difference in the characteristics of the analog circuit on the side of the terminal 12 is influence common to all antennas 15 of the base station 11. Thus, even with calibration in which only the base station 11 is taken into consideration, a beam can be correctly formed. In the system 10 according to embodiment example 1, in order for each base station 11 to form a proper transmit beam, calibration to compensate for the difference in the characteristics of the analog circuits between the transmitting system and the receiving system of each antenna 15 is performed between the base stations 11.

[Configuration of Base Station]

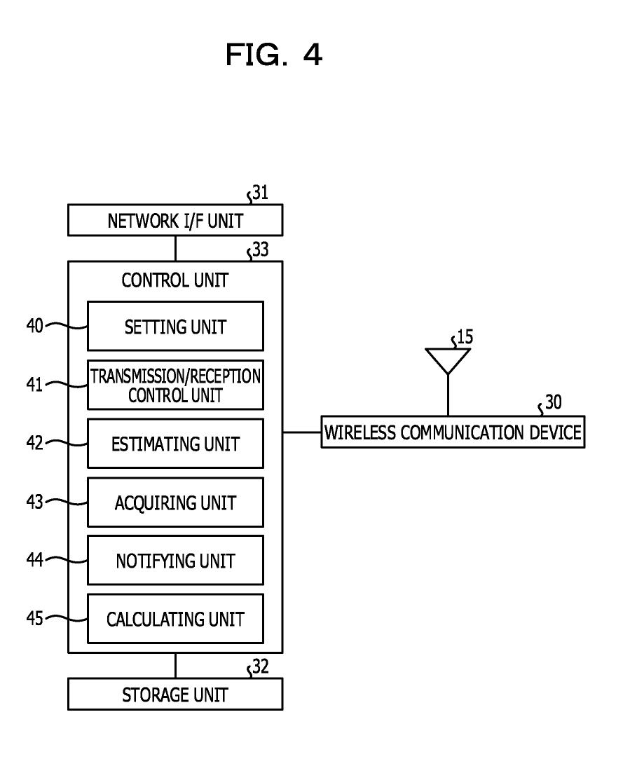

Next, the configuration of the base station 11 according to embodiment example 1 will be described. FIG. 4 is a diagram illustrating a schematic configuration of a base station. As illustrated in FIG. 4, the base station 11 includes a wireless communication device 30, a network interface (I/F) unit 31, a storage unit 32, and a control unit 33.

The plural antennas 15 are coupled to the wireless communication device 30. In the example of FIG. 4, only one antenna 15 is illustrated for simplification. The wireless communication device 30 is provided with an analog circuit used for signal transmission and reception by the antennas 15. For example, in the wireless communication device 30, the analog circuit (TX) of the transmitting system and the analog circuit (RX) of the receiving system are provided for each antenna 15.

The network I/F unit 31 is an interface that carries out communication control with other devices. For example, the network I/F unit 31 is coupled to a backbone wired network configuring a mobile communication network and is allowed to transmit and receive various kinds of information to and from other base stations 11.

The storage unit 32 is a storage device that stores various kinds of data. For example, the storage unit 32 is storage apparatus such as a hard disc, a solid state drive (SSD), or an optical disc. The storage unit 32 may be a data-rewritable semiconductor memory such as a random access memory (RAM), a flash memory, or a non volatile static random access memory (NVSRAM).

The control unit 33 is a device that controls the base station 11. As the control unit 33, a processor such as a central processing unit (CPU) or a micro processing unit (MPU) or an integrated circuit such as an application specific integrated circuit (ASIC) or a field programmable gate array (FPGA) can be employed. The control unit 33 has an internal memory for storing programs and control data in which various kinds of processing procedures are prescribed and executes various kinds of processing on the basis of these programs and data. The control unit 33 functions as various kinds of processing units through operation of various kinds of programs. For example, the control unit 33 includes a setting unit 40, a transmission/reception control unit 41, an estimating unit 42, an acquiring unit 43, a notifying unit 44, and a calculating unit 45.

The setting unit 40 makes various kinds of settings. For example, in the case of performing calibration, the setting unit 40 sets the communication timing to generate timings at which UL and DL alternately overlap between the base station 11 including this setting unit 40 and another base station 11 as the calibration counterpart. As this base station 11 as the calibration counterpart, the base station 11 adjacent to the base station 11 that carries out the calibration is employed. For example, the calibration is carried out between two base stations 11 adjacent to each other like those illustrated in FIG. 1. For example, the setting unit 40 synchronizes the timing of the frame with the other base station 11 as the calibration counterpart. Furthermore, the setting unit 40 acquires the setting of the DL/UL configuration of the other base station 11. The setting unit 40 may carry out the synchronization of the timing of the frame with the other base station 11 and the acquisition of the setting of the DL/UL configuration of the other base station 11 by communicating with the other base station 11 via a wired network by using the network I/F unit 31. Alternatively, the setting unit 40 may carry out the synchronization of the timing of the frame with the other base station 11 and the acquisition of the setting of the DL/UL configuration of the other base station 11 by receiving a DL signal of the other base station 11.

The setting unit 40 sets, as the DL/UL configuration of the communication area, the DL/UL configuration with which timings at which UL and DL alternately overlap with the DL/UL configuration acquired from the other base station 11 are generated. This set DL/UL configuration of the communication area is notified to the terminal 12 in the communication area by the notifying unit 44.

The transmission/reception control unit 41 carries out control of transmission and reception of data. For example, the transmission/reception control unit 41 makes switching between transmission and reception of the wireless communication device 30 in a time-division manner on the basis of the DL/UL configuration set by the setting unit 40. Then, the transmission/reception control unit 41 carries out control to transmit a reference signal and a data signal at the timing of DL. Furthermore, the transmission/reception control unit 41 carries out control to receive an UL signal from the terminal 12 and a DL signal from the other base station 11 at the timing of UL.

The estimating unit 42 carries out various kinds of estimations. For example, the estimating unit 42 performs a channel estimation on the basis of the DL signal of the other base station 11.

The notifying unit 44 notifies the other base station 11 of an estimation result arising from the channel estimation performed by the estimating unit 42 about the DL signal of the other base station 11. The notifying unit 44 may carry out this notification to the other base station 11 via a backbone wired network of mobile communications by the network I/F unit 31. Alternatively, the notifying unit 44 may carry out the notification to the other base station 11 by wireless communications by the transmission/reception control unit 41.

The acquiring unit 43 carries out various kinds of acquisition. For example, the acquiring unit 43 acquires an estimation result arising from a channel estimation performed by the other base station 11 on the basis of a DL signal from the base station 11 including this acquiring unit 43. The other base station 11 may notify this base station 11 of this estimation result when obtaining the estimation result arising from the channel estimation from the DL signal from this base station 11. Alternatively, the acquiring unit 43 may request the other base station 11 to transmit the estimation result and the other base station 11 may transmit the estimation result in response to the request.

The calculating unit 45 carries out various kinds of calculations. For example, the calculating unit 45 calculates a correction coefficient to compensate for the characteristic difference among the antennas 15 on the basis of the estimation result by the estimating unit 42 and the estimation result acquired by the acquiring unit 43. If the correction coefficient is calculated by the calculating unit 45, the transmission/reception control unit 41 performs precoding by the correction coefficient calculated by the calculating unit 45 and carries out transmission of data.

Here, a description will be made by using a specific example. In the present embodiment example, a description will be made by taking as an example the case in which calibration is carried out between the two base stations 11 illustrated in FIG. 1. Hereinafter, in the case of differentiating the two base stations 11, the base stations 11 will be represented as the base stations #1 and #2. Furthermore, the terminal 12 in the communication area of the base station #1 will be defined as the terminal #1 and the terminal 12 in the communication area of the base station #2 will be represented as the terminal #2.

In the case of performing calibration between the two base stations #1 and #2, the setting units 40 of the base stations #1 and #2 set the DL/UL configuration to generate timings at which UL and DL alternately overlap.

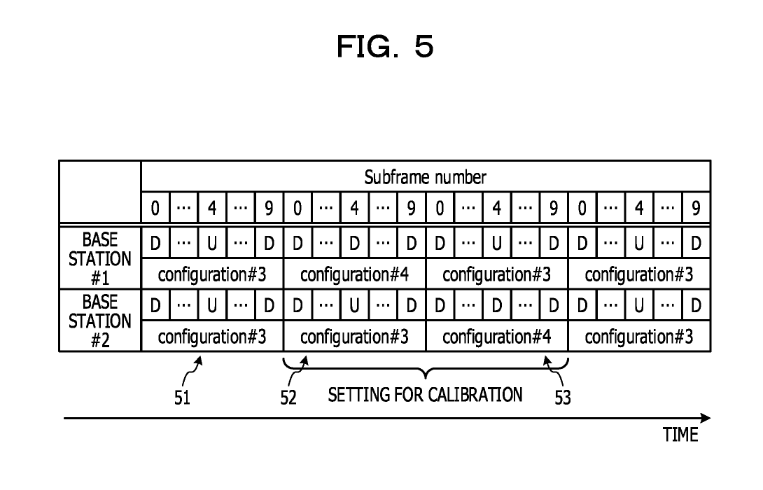

FIG. 5 is a diagram illustrating one example of a setting of a DL/UL configuration. If the setting is the DL/UL configuration #3 as represented in a frame 51 in FIG. 5, the base station #1 sets the DL/UL configuration to the DL/UL configuration #4 in a frame 52, in which the setting of the base station #2 is the DL/UL configuration #3. The base station #2 sets the DL/UL configuration to the DL/UL configuration #4 in a frame 53, in which the setting of the base station #1 is the DL/UL configuration #3. Between the DL/UL configurations #3 and #4, the setting about DL and UL is different at the subframe #4. In the frames 52 and 53, the subframes #4 are the timings at which UL and DL alternately overlap. The base stations #1 and #2 carry out the calibration at these timings at which UL and DL alternately overlap with each other.

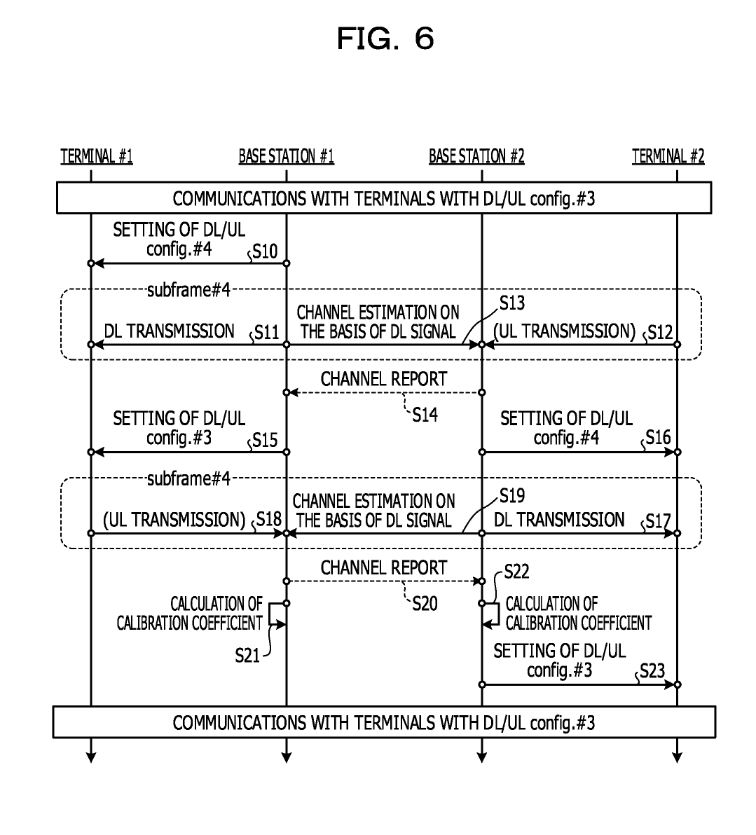

FIG. 6 is a sequence diagram illustrating one example of a flow of calibration. Suppose that, in the example of FIG. 6, initially the setting in the base stations #1 and #2 is the DL/UL configuration #3.

The base station #1 notifies the terminal #1 in the communication area of the DL/UL configuration #4 (S10). Due to this, in the period of the subframe #4, DL is set in the communication area of the base station #1 and UL is set in the communication area of the base station #2.

The base station #1 performs DL transmission in the period of the subframe #4 (S11). The terminal #1 in the communication area of the base station #1 can receive a DL signal from the base station #1 because the period of the subframe #4 is the DL. Meanwhile, in the communication area of the base station #2, the period of the subframe #4 is the UL. Therefore, the terminal #2 in the communication area of the base station #2 performs UL transmission (S12). The base station #2 can receive both an UL signal from the terminal #2 and the DL signal from the base station #1 because the period of the subframe #4 is the UL. The base station #2 carries out a channel estimation from the DL signal from the base station #1 (S13). Then, the base station #2 notifies the base station #1 of the estimation result of the channel estimation (S14).

Next, the base station #1 notifies the terminal #1 in the communication area of the DL/UL configuration #3 (S15). Furthermore, the base station #2 notifies the terminal #2 in the communication area of the DL/UL configuration #4 (S16). Due to this, in the period of the subframe #4, UL is set in the communication area of the base station #1 and DL is set in the communication area of the base station #2.

The base station #2 performs DL transmission in the period the subframe #4 (S17). The terminal #2 in the communication area of the base station #2 can receive a DL signal from the base station #2 because the period of the subframe #4 is the DL. Meanwhile, in the communication area of the base station #1, the period of the subframe #4 is the UL. Therefore, the terminal #1 in the communication area of the base station #1 performs UL transmission (S18). The base station #1 can receive both an UL signal from the terminal #1 and the DL signal from the base station #2 because the period of the subframe #4 is the UL. The base station #1 carries out a channel estimation from the DL signal from the base station #2 (S19). Then, the base station #1 notifies the base station #2 of the estimation result of the channel estimation (S20).

The base station #1 calculates the correction coefficient to compensate for the characteristic difference among the antennas 15 on the basis of the estimation result obtained by the channel estimation from the DL signal of the base station #2 and the estimation result notified from the base station #2 (S21). The base station #2 calculates the correction coefficient to compensate for the characteristic difference among the antennas 15 on the basis of the estimation result obtained by the channel estimation from the DL signal of the base station #1 and the estimation result notified from the base station #1 (S22).

Upon the completion of the calibration, the setting of the DL/UL configuration is returned to the state before the calibration. For example, the base station #2 notifies the terminal #2 in the communication area of the DL/UL configuration #3 (S23). This causes the base station #1 and the base station #2 to perform communications with the initial setting with the DL/UL configuration #3.

Next, the flow of the calculation to figure out the correction coefficient will be described. In the following, an example in which the correction coefficient to compensate for the characteristic difference among the plural antennas 15 of the base station #1 is calculated will be described. Hereinafter, the number of antennas 15 of each base station 11 (#1, #2) will be defined as K and the number of antennas 16 of each terminal 12 will be described as L. In the case of individually indicating each of the antennas 15 of the respective base stations 11 and the antennas 16 of the respective terminals 12, the antenna 15 or 16 will be so represented as to be given a number #i for example. Also when the number of antennas is different among the respective base stations 11 and among the terminals 12, the correction coefficient can be calculated by a similar method.

In S13 in FIG. 6, on the basis of the DL signal transmitted by the base station #1, the base station #2 estimates an inter-base station channel G_{eff,1} including a variation attributed to the analog circuit (TX) of the transmitting system of the base station #1 and a variation attributed to the analog circuit (RX) of the receiving system of the base station #2.

This inter-base station channel G_{eff,1} is expressed by the following expression (1).

G_{eff,1}=A_{RX,2}·G·A_{TX,1} (1)

Here, A_{RX,2} is a K×K diagonal matrix in which the i-th row, i-th column element is a variation a_{RX,2,i} attributed to the analog circuit (RX) of the receiving system of the antenna #i of the base station #2. A_{TX,1} is a K×K diagonal matrix in which the i-th row, i-th column element is a variation a_{TX,1,i} attributed to the analog circuit (TX) of the transmitting system of the antenna #i of the base station #1. G is a K×K matrix in which the i-th row, j-th column element is a channel g_{i,j} between the antenna #i of the base station #2 and the antenna #j of the base station #1.

As described above, the base station #1 can perform DL transmission to the terminal #1 in the communication area as usual. Although the base station #2 can receive UL transmission from the terminal #2 in the communication area, the base station #2 may carry out control to stop the UL transmission of the terminal #2 at least in part of the band in order to enhance the accuracy of the channel estimation between the base stations 11. For example, the notifying unit 44 may carry out control to notify the terminal 12 of stop of signal transmission at the timing of UL in the timings at which UL and DL alternately overlap and stop the UL transmission of the terminal 12. Furthermore, the base station #1 may set the transmission power of the reference signal for the channel estimation high to perform the DL transmission in order to enhance the accuracy of the channel estimation between the base stations 11. For example, the transmission/reception control unit 41 may carry out control to increase the transmission power of the signal at the timing of DL in the timings at which UL and DL alternately overlap.

In S14 in FIG. 6, the base station #2 notifies the base station #1 of the estimated inter-base station channel G_{eff,1}. Here, the report of the inter-base station channel is carried out by using an inter-base station interface such as a wired connection.

In S19 in FIG. 6, on the basis of the DL signal transmitted by the base station #2, the base station #1 estimates an inter-base station channel G_{eff,2} including a variation attributed to the analog circuit (TX) of the transmitting system of the base station #2 and a variation attributed to the analog circuit (RX) of the receiving system of the base station #1 by a method similar to expression (1).

In S20 in FIG. 6, the base station #1 notifies the base station #2 of the estimated inter-base station channel G_{eff,2}.

Then, in S21 and S22 in FIG. 6, the base stations #1 and #2 each carry out inter-antenna calibration. Here, a description will be made about a method in which the base station #1 carries out the calibration on the basis of the information on the channel between the antenna 15 of the base station #1 and the antenna #i of the base station #2. The antenna 15 to be utilized in the base station #2 can be arbitrarily selected. For example, it will be possible to utilize the channel with the antenna 15 having high reception quality. Hereinafter, the antenna 15 having high reception quality will be described as the antenna #1.

The base station #1 calculates a calibration coefficient C_{1,k} to align the characteristic difference between the analog circuits of the antenna #k with the characteristic difference of the antenna #1 by the following expression (2).

$$\begin{matrix}[ Expression 1 ] & \\ {C}_{1 , k} = \frac{{g}_{eff , 2 , 1 , i} {g}_{eff , 1 , i , k}}{{g}_{eff , 1 , i , 1} {g}_{eff , 2 , k , i}} = ( \frac{{a}_{RX , 1 , 1}}{{a}_{TX , 1 , 1}} ) \cdot ( \frac{{a}_{TX , 1 , k}}{{a}_{RX , 1 , k}} ) & ( 2 )\end{matrix}$$

In this expression, g_{eff,1,i,k} is the i-th row, k-th column element of the inter-base station channel G_{eff,1}, and represents a channel between the base stations 11 including a variation attributed to the analog circuit (RX) of the receiving system of the antenna #i of the base station #2 and a variation attributed to the analog circuit (TX) of the transmitting system of the antenna #k of the base station #1. Furthermore, g_{eff,2,i,k} is the i-th row, k-th column element of the inter-base station channel G_{eff,2}. Here, it is assumed that the channel estimation and the channel report to the other base station 11 can be ideally carried out. Furthermore, it is assumed that the channel estimation in each base station 11 is carried out at sufficiently short intervals relative to the coherence time. The calibration coefficient to align the characteristic difference between the analog circuits with the characteristic difference of the antenna 15 other than the antenna #1 can also be calculated by the similar method. For example, if the antenna 15 about which the characteristic difference between transmission and reception is small is known in advance, it will be possible to align the characteristic difference with the characteristic difference of this antenna 15. The calibration coefficient of the base station #2 can also be calculated by the similar method.

From then on, when forming a DL transmit beam to the terminal #1 or #2, the base station #1 or #2 forms the beam on the basis of channel information obtained by correcting channel information estimated with an UL signal by the calibration coefficient. For example, a channel estimate after the correction for the terminal #1 of the base station #1 is expressed by the following expression (3).

[Expression 2]

H_{eff,1,1,UL}^{T}·diag(c_{1,1}, . . . ,c_{1,K1})=E₁H_{eff,1,1,DL} (3)

In this expression, E₁ is expressed by the following expression (4).

$$\begin{matrix}[ Expression 3 ] & \\ {E}_{1} = ( \frac{{a}_{RX , 1 , 1}}{{a}_{TX , 1 , 1}} ) {B}_{TX , 1} {B}_{RX , 1}^{- 1} & ( 4 )\end{matrix}$$

Here, H_{eff,1,1,UL} is an UL channel between the base station #1 and the terminal #1, estimated by the base station #1 (including variations of the analog circuits). H_{eff,1,1,DL} is a DL channel between the base station #1 and the terminal #1 including variations of the analog circuits. B_{RX,1} is an L×L diagonal matrix in which the i-th row, i-th column element is a variation b_{RX,1,i} attributed to the analog circuit (RX) of the receiving system of the antenna #i of the terminal #1. B_{TX,1} is an L×L diagonal matrix in which the i-th row, i-th column element is a variation b_{TX,1,i} attributed to the analog circuit (TX) of the transmitting system of the antenna #i of the terminal #1.

E₁ is a variation common to the respective transmitting antennas and therefore does not affect the direction of the beam. Thus, for example, also at the time of transmission of plural streams, communications can be performed without the need for the report from the terminal and without the occurrence of inter-stream interference.

As above, by carrying out the channel estimation between base stations by utilizing the DL/UL configurations with which DL and UL alternately overlap between the base stations, calibration using information on the channel between the base stations is enabled without adversely affecting control of the terminal.

[Flow of Processing]

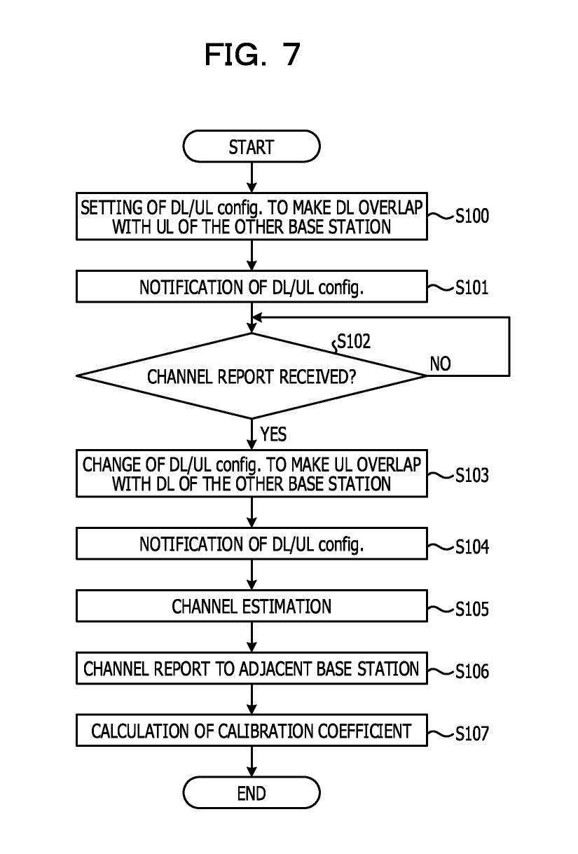

Next, a description will be made about the flow of the calibration processing in which the base station 11 according to the present embodiment example performs calibration. FIG. 7 is a flowchart illustrating one example of a procedure of calibration processing. The example of FIG. 7 represents the flow of execution of the calibration processing with the sequence illustrated in FIG. 6 by the base station #1.

As illustrated in FIG. 7, in the case of performing the calibration with the base station #2, the setting unit 40 sets the DL/UL configuration with which a timing at which DL of the base station #1 overlaps with UL of the base station #2 is generated (S100). For example, in the example of FIG. 6, the setting unit 40 sets the DL/UL configuration #4. The notifying unit 44 notifies the terminal 12 in the communication area of the set DL/UL configuration (S101).

When a DL signal from the base station #1 is received, the base station #2 carries out a channel estimation from the DL signal. The base station #2 notifies the base station #1 of the estimation result of the channel estimation.

The acquiring unit 43 determines whether the estimation result obtained by the channel estimation is received from the base station #2 (S102). If the estimation result is not received (No of S102), transition to S102 is made again and reception of the estimation result is awaited.

If the estimation result is received (Yes of S102), subsequently the setting unit 40 sets the DL/UL configuration in order to generate a timing at which UL of the base station #1 overlaps with DL of the base station #2 (S103). For example, in the example of FIG. 6, the setting unit 40 sets the DL/UL configuration #3. The notifying unit 44 notifies the terminal 12 in the communication area of the set DL/UL configuration (S104).

The base station #2 changes the setting to the DL/UL configuration #4.

Upon receiving a DL signal from the base station #2, the estimating unit 42 carries out a channel estimation from the DL signal (S105). The notifying unit 44 notifies the base station #2 of the estimation result (S106). The calculating unit 45 calculates the correction coefficient to compensate for the characteristic difference among the antennas 15 on the basis of the estimation result of S105 and the estimation result received in S102 (S107), and ends the processing.

[Effect]

As described above, the base station 11 according to the present embodiment example carries out a channel estimation on the basis of a signal transmitted from another base station 11 in an uplink segment (UL) of the base station 11 overlapping with a downlink segment (DL) of the other base station 11 in communications of a time-division system using the plural antennas 15. The base station 11 acquires an estimation result arising from a channel estimation by the other base station 11 on the basis of a signal transmitted by the base station 11 in an uplink segment of the other base station 11 overlapping with a downlink segment of the base station 11. The base station 11 calculates the correction coefficient to compensate for the characteristic difference among the plural antennas 15 on the basis of the estimation result obtained by the estimation and the acquired estimation result. Here, the other base station 11 does not move and the reception quality of the other base station 11 is also favorable in many cases. Thus, the base station 11 can accurately carry out calibration by carrying out the calibration with the other base station 11. Furthermore, the base station 11 carries out the channel estimation at the timing when an uplink segment of the base station 11 overlaps with a downlink segment of the other base station 11. This allows the base station 11 to carry out the calibration with suppression of the influence on communications with the terminal 12 in the communication area.

The adjacent base stations 11 generally carry out TDD with the same DL/UL configuration. In this case, the timings of DL and UL synchronize among the adjacent base stations 11. Here, for example, if any base station 11 employs a period of DL of another base station 11 as a period to receive a signal in order to receive a signal from the other base station 11, this base station 11 becomes incapable of sending a DL signal to the terminal 12 in this base station 11. Furthermore, if any base station 11 employs a period of UL of another base station 11 as a period to transmit a signal in order to transmit a signal to the other base station 11, this base station 11 becomes incapable of receiving a signal from the terminal 12 in this base station 11. Then, the base station 11 according to the present embodiment example sets the switching pattern of the uplink segment and the downlink segment (DL/UL configuration) with which an uplink segment overlaps with a downlink segment in the switching pattern (DL/UL configuration) set in the other base station 11. This allows the base station 11 to carry out the calibration with suppression of the influence on communications with the terminal 12 in the communication area.

Furthermore, the base station 11 according to the present embodiment example notifies the terminal 12 in the communication area of the base station 11 of stop of transmission of a signal in a segment in which a downlink segment of the other base station 11 overlaps with an uplink segment of the base station 11. This allows the base station 11 to accurately detect a signal of the other base station 11 because the base station 11 notifies the terminal 12 in the communication area of the base station 11 of stop of transmission of a signal.

Moreover, the base station 11 according to the present embodiment example controls the transmission power of a signal to increase the transmission power in a segment in which an uplink segment of the other base station 11 overlaps with a downlink segment of the base station 11. Due to this, the base station 11 can allow the other base station 11 to accurately detect a signal of the base station 11.

### Embodiment Example 2

Next, embodiment example 2 will be described. The configurations of the system 10 and the base station 11 according to embodiment example 2 are the same as those of embodiment example 1 illustrated in FIGS. 1 to 4. Therefore, the same part is given the same numeral and different parts will be mainly described.

As described above, the special subframe of the DL/UL configuration is set at the timing of switching from DL to UL. In communications of the TDD system, after receiving a DL signal, the terminal 12 switches the circuit to the transmitting circuit and performs UL transmission. It takes time depending on propagation delay for an UL signal from the terminal 12 to reach the base station 11 after the base station 11 transmits a DL signal. In the case of ensuring the time depending on propagation delay by the special subframe, the base station 11 performs neither DL transmission nor UL reception during the special subframe. In the 3GPP, DL and UL are set in units of one subframe. Execution of no communication during one subframe leads to low communication efficiency.

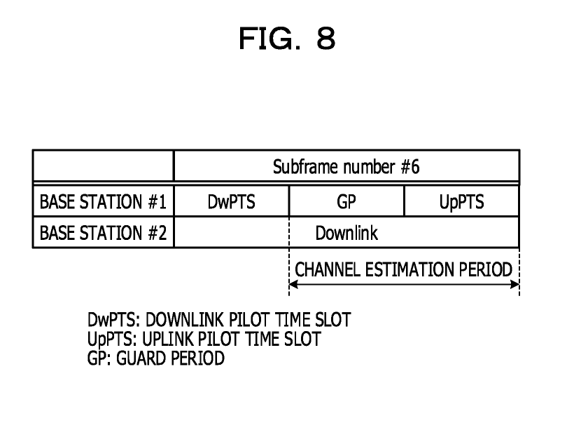

FIG. 8 is a diagram illustrating one example of a data configuration of a special subframe. In the special subframe, a period in which DL transmission is performed (DwPTS; Downlink Pilot Time Slot), a period in which neither DL transmission nor UL reception is performed (GP; Guard Period), and a period in which UL reception is performed (UpPTS; Uplink Pilot Time Slot) are set in one subframe.

In the base station 11 according to embodiment example 2, the setting unit 40 sets the communication timing to generate a timing at which the switching period from DL to UL overlaps with DL of the other base station 11. In the present embodiment example, by using the DL/UL configurations #2 and #3, the setting unit 40 sets the communication timing to generate the timing at which the special subframe as the switching period from DL to UL overlaps with the DL.

The estimating unit 42 carries out a channel estimation on the basis of a DL signal of the other base station 11 at the timing at which the switching period overlaps with the DL of the other base station 11.

Here, a description will be made by using a specific example. Also in the present embodiment example, a description will be made by taking as an example the case in which calibration is performed between the base stations #1 and #2 illustrated in FIG. 1.

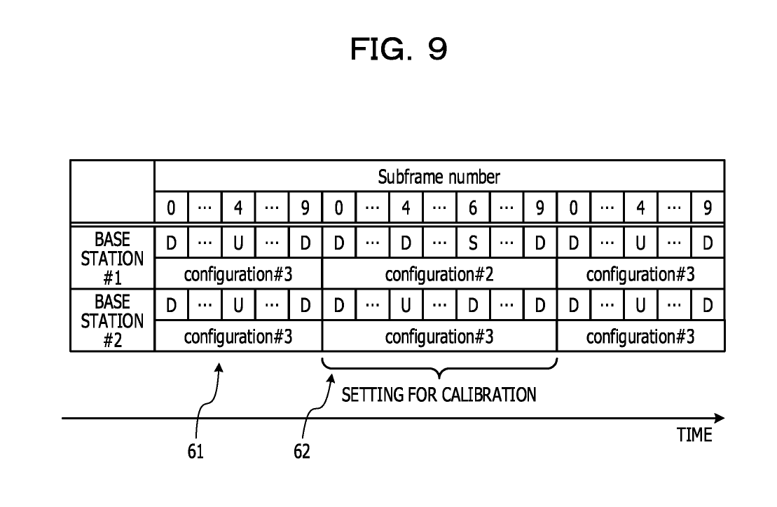

FIG. 9 is a diagram illustrating one example of a setting of a DL/UL configuration. If the setting is the DL/UL configuration #3 as represented in a frame 61 in FIG. 9, the base station #1 sets the DL/UL configuration to the DL/UL configuration #2 in a frame 62, in which the setting of the base station #2 is the DL/UL configuration #3. In the frame 62, the subframe #4 is a timing at which UL and DL overlap. Furthermore, in the frame 62, the subframe #6 is the timing at which a special subframe and DL overlap. The base station #2 carries out a channel estimation at the timing of the subframe #4. The base station #1 carries out a channel estimation at the timing of the subframe #6.

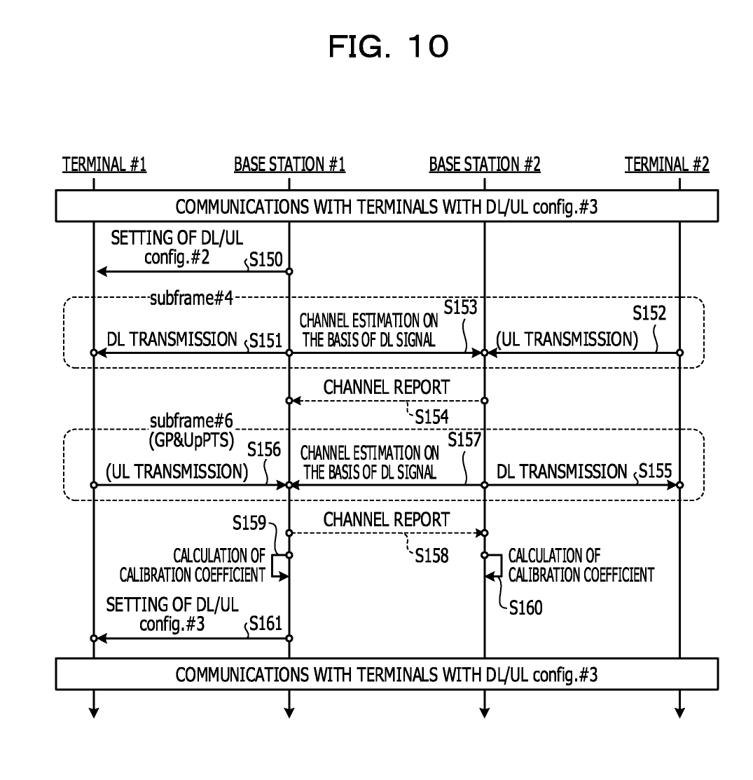

FIG. 10 is a sequence diagram illustrating one example of a flow of calibration. Suppose that, in the example of FIG. 10, initially the setting in the base stations #1 and #2 is the DL/UL configuration #3.

The base station #1 notifies the terminal #1 in the communication area of the DL/UL configuration #2 (S150). Due to this, in the period of the subframe #4, DL is set in the communication area of the base station #1 and UL is set in the communication area of the base station #2. Furthermore, in the period of the subframe #6, a special subframe is set in the communication area of the base station #1 and DL is set in the communication area of the base station #2.

The base station #1 performs DL transmission in the period of the subframe #4 (S151). The terminal #1 in the communication area of the base station #1 can receive a DL signal from the base station #1 because the period of the subframe #4 is the DL. Meanwhile, in the communication area of the base station #2, the period of the subframe #4 is the UL. Therefore, the terminal #2 in the communication area of the base station #2 performs UL transmission (S152). The base station #2 can receive both an UL signal from the terminal #2 and the DL signal from the base station #1 because the period of the subframe #4 is the UL. The base station #2 carries out a channel estimation from the DL signal from the base station #1 (S153). Then, the base station #2 notifies the base station #1 of the estimation result of the channel estimation (S154).

Next, upon the start of the period of the subframe #6, the base station #2 performs DL transmission (S155). Meanwhile, in the communication area of the base station #1, the period of the subframe #6 is the special subframe. Therefore, the terminal #1 in the communication area of the base station #1 performs UL transmission in the period of DwPTS of the special subframe (S156). The base station #1 can receive an UL signal from the terminal #1 and a DL signal from the base station #2 in the period of GP of the special subframe. The base station #1 carries out a channel estimation from the DL signal from the base station #2 (S157). The base station #1 notifies the base station #2 of the estimation result of the channel estimation (S158).

The base station #1 calculates the correction coefficient to compensate for the characteristic difference among the antennas 15 on the basis of the estimation result obtained by the channel estimation from the DL signal of the base station #2 and the estimation result notified from the base station #2 (S159). The base station #2 calculates the correction coefficient to compensate for the characteristic difference among the antennas 15 on the basis of the estimation result obtained by the channel estimation from the DL signal of the base station #1 and the estimation result notified from the base station #1 (S160).

Upon the completion of the calibration, the setting of the DL/UL configuration is returned to the state before the calibration. For example, the base station #1 notifies the terminal #1 in the communication area of the DL/UL configuration #3 (S161). This causes the base station #1 and the base station #2 to perform communications with the initial setting with the DL/UL configuration #3.

In the period of GP of the special subframe, UL transmission is not performed originally. Therefore, by carrying out the channel estimation between the base stations 11 by utilizing this period of GP, the channel estimation between the base stations 11 under the situation without interference attributed to UL transmission by the terminal 12 is enabled.

[Flow of Processing]

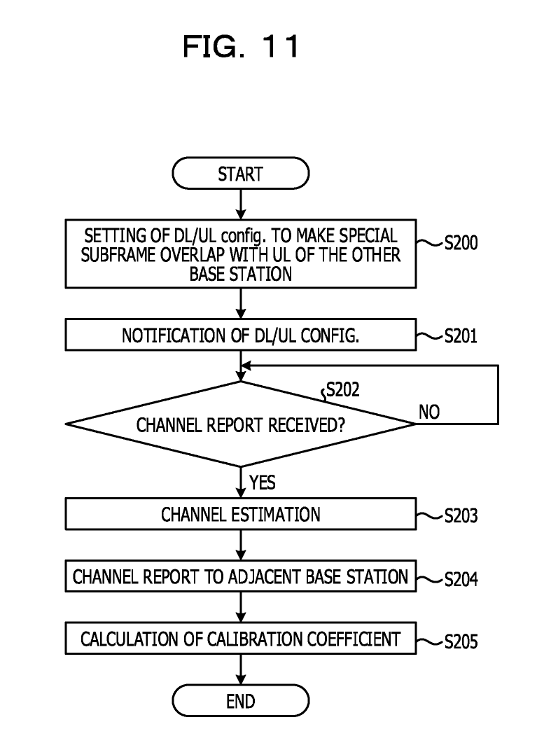

Next, a description will be made about the flow of the calibration processing in which the base station 11 according to the present embodiment example performs calibration. FIG. 11 is a flowchart illustrating one example of a procedure of calibration processing. The example of FIG. 11 represents the flow of execution of the calibration processing with the sequence illustrated in FIG. 10 by the base station #1.

As illustrated in FIG. 11, in the case of performing the calibration with the base station #2, the setting unit 40 sets the DL/UL configuration with which a timing at which a special subframe of the base station #1 overlaps with UL of the base station #2 is generated (S200). For example, in the example of FIG. 10, the setting unit 40 sets the DL/UL configuration #2. The notifying unit 44 notifies the terminal 12 in the communication area of the set DL/UL configuration (S201).

When a DL signal from the base station #1 is received in the period of the subframe #4, the base station #2 carries out a channel estimation from the DL signal. The base station #2 notifies the base station #1 of the estimation result of the channel estimation.

The acquiring unit 43 determines whether the estimation result obtained by the channel estimation is received from the base station #2 (S202). If the estimation result is not received (No of S202), transition to S202 is made again and reception of the estimation result is awaited.

If the estimation result is received (Yes of S202), transition to S203 to be described below is made.

Upon receiving a DL signal from the base station #2, the estimating unit 42 carries out a channel estimation from the DL signal (S203). The notifying unit 44 notifies the base station #2 of the estimation result (S204). The calculating unit 45 calculates the correction coefficient to compensate for the characteristic difference among the antennas 15 on the basis of the estimation result of S203 and the estimation result received in S202 (S205), and ends the processing.

[Effect]

As described above, the base station 11 according to the present embodiment example sets the switching pattern of the uplink segment and the downlink segment with which a switching segment from a downlink segment to an uplink segment (special subframe) overlaps with a downlink segment in the switching pattern set in the other base station 11. This allows the base station 11 to carry out the channel estimation under the situation without interference attributed to UL transmission by the terminal 12 in the communication area of this base station 11.

### Embodiment Example 3

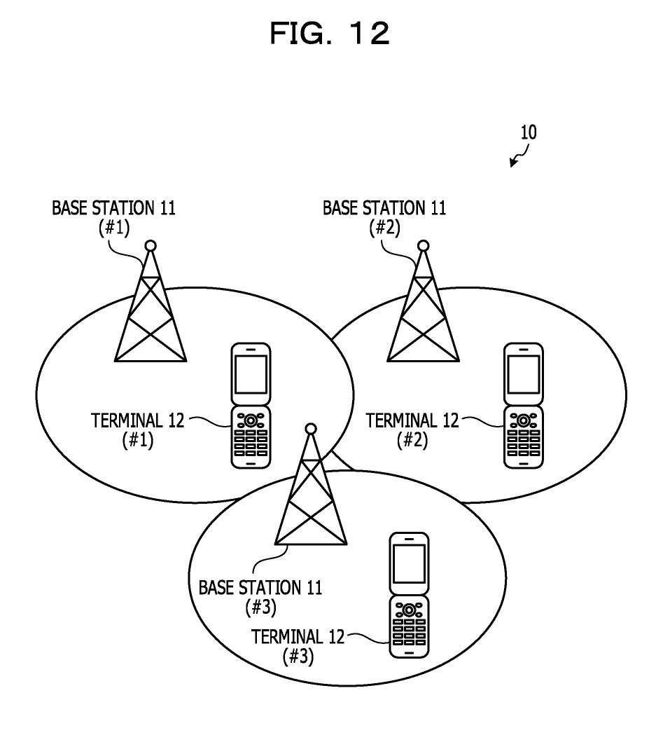

Next, embodiment example 3 will be described. FIG. 12 is a diagram for explaining one example of a system configuration. The system 10 has three base stations 11. The configuration of the base station 11 according to embodiment example 3 is the same as that of embodiment example 1 illustrated in FIG. 4. Therefore, the same part is given the same numeral and different parts will be mainly described. Furthermore, although a case in which the number of base stations 11 is three is exemplified in the example of FIG. 12, the number of base stations 11 is not limited thereto and can be set to an arbitrary number as long as the number is three or more. Moreover, in the example of FIG. 12, a case in which the number of terminals 12 is three is exemplified. However, the number of terminals 12 is also not limited thereto and can be set to an arbitrary number. Each base station 11 is allowed to wirelessly communicate with the terminal 12 in a communication area. In the example of FIG. 12, the communication areas of the respective base stations 11 are each represented by an ellipse and each one terminal 12 is represented in the communication area of the base station 11. The base station 11 communicates with the terminal 12 in the communication area by a TDD system with use of the same frequency.

In the system 10 according to embodiment example 3, the three base stations 11 are divided into groups. For example, plural base stations whose reference signals for the channel estimation are orthogonal to each other are collected into a group. Then, DL and UL are made to alternately overlap between the groups and calibration is carried out between the groups.

Here, a description will be made by using a specific example. In the present embodiment example, a description will be made by taking as an example the case in which calibration is carried out among the three base stations 11 illustrated in FIG. 12. Hereinafter, in the case of differentiating the three base stations 11, the base stations 11 will be represented as the base stations #1, #2, and #3. Furthermore, the terminal 12 in the communication area of the base station #1 will be defined as the terminal #1. The terminal 12 in the communication area of the base station #2 will be defined as the terminal #2. The terminal 12 in the communication area of the base station #3 will be represented as the terminal #3.

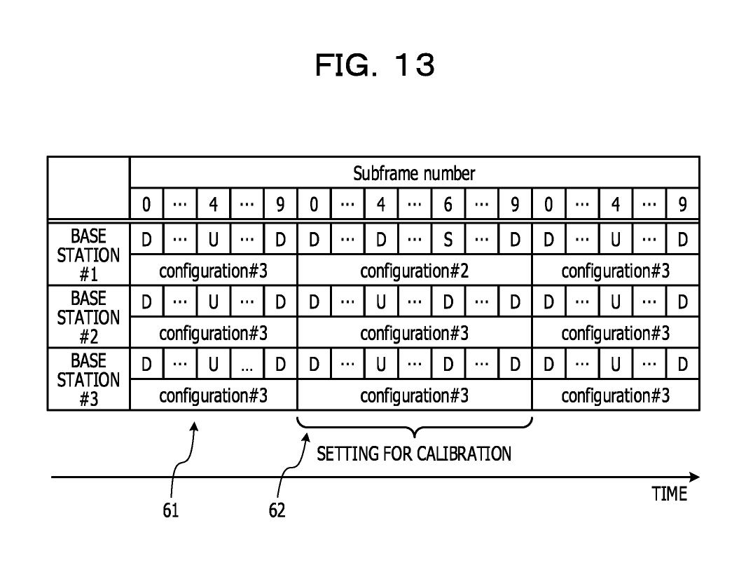

FIG. 13 is a diagram illustrating one example of a setting of a DL/UL configuration. Here, a case is assumed in which the base stations #1, #2, and #3 each perform communications with the terminal 12 with the DL/UL configuration #3 except for at the time of calibration. Furthermore, between the base stations #2 and #3, the reference signals to be transmitted for the channel estimation are orthogonal to each other. Thus, the base stations #2 and #3 are collected into one group and the base station #1 is regarded as another group.

If the setting is the DL/UL configuration #3 as represented in the frame 61 in FIG. 13, the base station #1 sets the DL/UL configuration to the DL/UL configuration #2 in the frame 62, in which the setting of the base stations #2 and #3 is the DL/UL configuration #3. In the frame 62, the subframe #4 is a timing at which UL and DL overlap. Furthermore, in the frame 62, the subframe #6 is a timing at which a special subframe and DL overlap. The base stations #2 and #3 carry out a channel estimation at the timing of the subframe #4. The base station #1 carries out a channel estimation at the timing of the subframe #6.

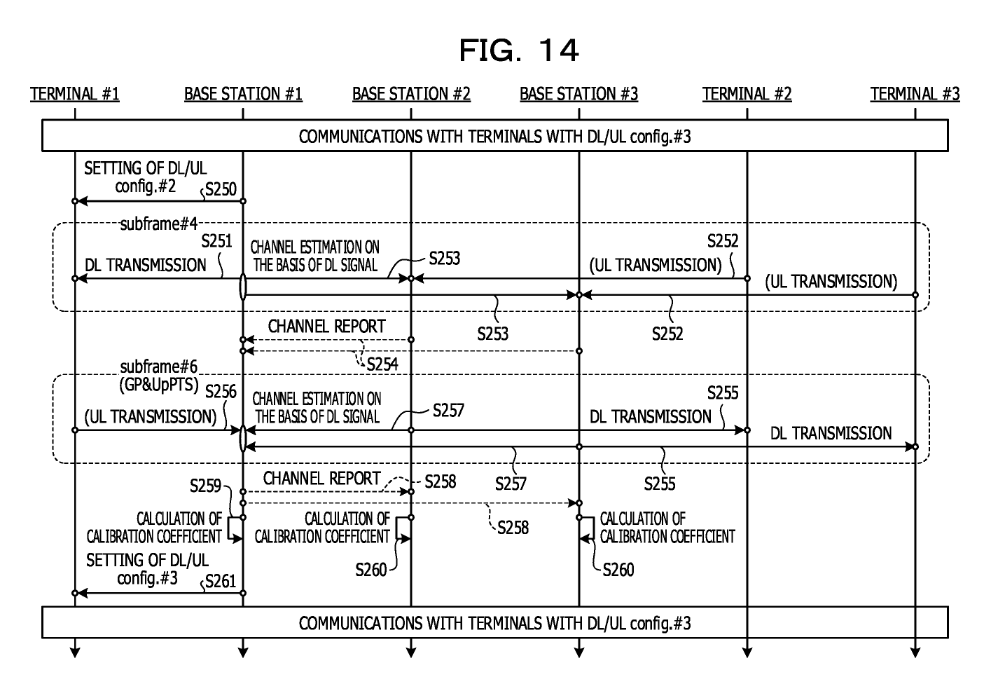

FIG. 14 is a sequence diagram illustrating one example of a flow of calibration. Suppose that, in the example of FIG. 14, initially the setting in the base stations #1, #2, and #3 is the DL/UL configuration #3.

The base station #1 notifies the terminal #1 in the communication area of the DL/UL configuration #2 (S250). Due to this, in the period of the subframe #4, DL is set in the communication area of the base station #1 and UL is set in the communication areas of the base stations #2 and #3. Furthermore, in the period of the subframe #6, a special subframe is set in the communication area of the base station #1 and DL is set in the communication areas of the base stations #2 and #3.

The base station #1 performs DL transmission in the period of the subframe #4 (S251). The terminal #1 in the communication area of the base station #1 can receive a DL signal from the base station #1 because the period of the subframe #4 is the DL. Meanwhile, in the communication areas of the base stations #2 and #3, the period of the subframe #4 is the UL. Therefore, the terminals #2 and #3 in the communication areas of the base stations #2 and #3 each perform UL transmission (S252). The base stations #2 and #3 can receive both an UL signal from the terminals #2 and #3 and the DL signal from the base station #1 because the period of the subframe #4 is the UL. The base stations #2 and #3 each carry out a channel estimation from the DL signal from the base station #1 (S253). Then, the base stations #2 and #3 notify the base station #1 of the estimation result of the channel estimation (S254).

Next, upon the start of the period of the subframe #6, the base stations #2 and #3 perform DL transmission (S255). Meanwhile, in the communication area of the base station #1, the period of the subframe #6 is the special subframe. Therefore, the terminal #1 in the communication area of the base station #1 performs UL transmission in the period of DwPTS of the special subframe (S256). The base station #1 can receive an UL signal from the terminal #1 and DL signals from the base stations #2 and #3 in the period of GP of the special subframe. The base station #1 carries out a channel estimation from the DL signals from the base stations #2 and #3 (S257). The base station #1 notifies each of the base stations #2 and #3 of the estimation result of the channel estimation (S258).

The base station #1 calculates the correction coefficient to compensate for the characteristic difference among the antennas 15 on the basis of the estimation result obtained by the channel estimation from the DL signals of the base stations #2 and #3 and the estimation results notified from the base stations #2 and #3 (S259). This correction coefficient may be obtained by calculating the correction coefficient about each of the base stations #2 and #3 and averaging these correction coefficients for example. Alternatively, if the reception sensitivity of the signal of either the base station #2 or #3 is high, the correction coefficient of the base station #2 or #3 of the high reception sensitivity may be calculated. The base stations #2 and #3 calculate the correction coefficient to compensate for the characteristic difference among the antennas 15 on the basis of the estimation result obtained by the channel estimation from the DL signal of the base station #1 and the estimation result notified from the base station #1 (S260).

Upon the completion of the calibration, the setting of the DL/UL configuration is returned to the state before the calibration. For example, the base station #1 notifies the terminal #1 in the communication area of the DL/UL configuration #3 (S261). This causes the base station #1 and the base stations #2 and #3 to perform communications with the initial setting with the DL/UL configuration #3.

By dividing the plural base stations 11 into groups and performing calibration between the groups in this manner, the calibration of the plural base stations 11 can be carried out in a shorter period than when the calibration is carried out between each pair of the base stations 11.

[Effect]

As described above, in the system 10 according to the present embodiment example, three or more base stations 11 are divided into a first base station group composed of part of the base stations 11 and a second base station group composed of the remaining base stations 11. Furthermore, the system 10 carries out calibration between the first base station group and the second base station group. This allows the system 10 to carry out the calibration of the plural base stations 11 in a shorter period than when the calibration is carried out between each pair of the base stations 11.

### Embodiment Example 4

Although embodiment examples relating to the system of the disclosure are described thus far, the techniques of the disclosure may be carried out in various different forms besides the above-described embodiment examples. Accordingly, another embodiment example encompassed in the techniques of the disclosure will be described below.

For example, although the cases in which calibration is performed between the base stations 11 are described in the above embodiment examples, the device of the disclosure is not limited thereto. For example, in the case of carrying out wireless communications between the terminals 12 having the plural antennas 16, calibration of the plural antennas 16 of each of the terminals 12 may be carried out between the terminals 12.

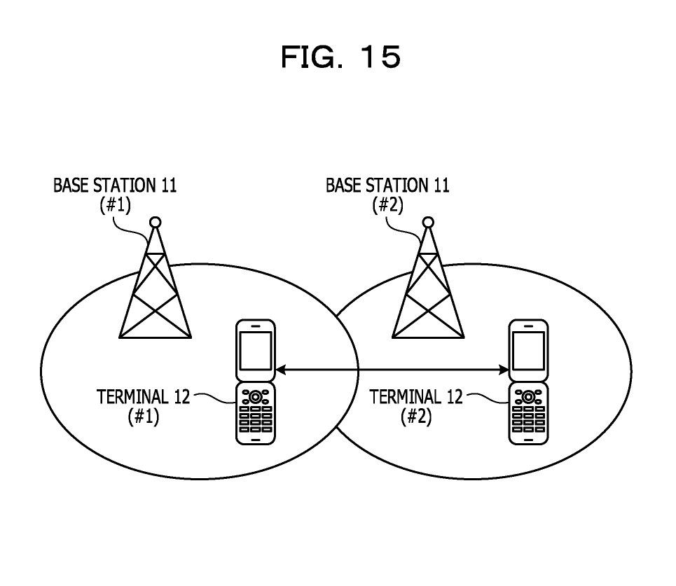

FIG. 15 is a diagram for explaining one example of a system configuration. In the system configuration, calibration is carried out between terminals. In the example of FIG. 15, the terminal #1 exists in the communication area of the base station #1 and the terminal #2 exists in the communication area of the base station #2. These terminals #1 and #2 are each provided with the plural antennas 16 and are allowed to directly communicate by communications of a time-division system using these plural antennas 16. In such a case, calibration may be carried out between the terminals 12 in the following manner. For example, the terminals #1 and #2 acquire each other's switching pattern of the uplink segment (UL) and the downlink segment (DL). This switching pattern may be acquired via the base station 11. For example, the terminal #1 may acquire the DL/UL configuration of the base station #2 via the base station #1. Furthermore, if the terminal #1 can receive a signal of the base station #2, the terminal #1 may acquire the switching pattern by receiving the DL/UL configuration transmitted by the base station #2. If the switching patterns of the terminals #1 and #2 synchronize, the terminals #1 and #2 do not need to acquire each other's switching pattern. The terminal #1 carries out a channel estimation on the basis of a signal transmitted from the terminal #2 in a downlink segment of the terminal #1 overlapping with an uplink segment of the terminal #2. Furthermore, the terminal #1 acquires an estimation result arising from a channel estimation by the terminal #2 on the basis of a signal transmitted by the terminal #1 in a downlink segment of the terminal #2 overlapping with an uplink segment of the terminal #1. Then, the terminal #1 may calculate a correction coefficient to compensate for the characteristic difference among the plural antennas 16 on the basis of the estimation result obtained by the estimation and the acquired estimation result.

Furthermore, each of the constituent elements of the respective devices illustrated in the drawings is functionally conceptual and does not necessarily need to be configured as illustrated in the drawings physically. Specifically, specific states of distribution and integration of the respective devices are not limited to those illustrated in the drawings and all or part thereof can be so configured as to be distributed and integrated functionally or physically in arbitrary unit depending on various kinds of loads, use status, and so forth. For example, the respective processing units of the setting unit 40, the transmission/reception control unit 41, the estimating unit 42, the acquiring unit 43, the notifying unit 44, and the calculating unit 45 may be integrated as appropriate. Furthermore, the processing of the respective processing units may be separated into processing of plural processing units as appropriate. Moreover, all or an arbitrary part of the respective processing functions carried out in the respective processing units can be implemented by a CPU or a program analyzed and executed in this CPU or be implemented as hardware by wired logic.

[Calibration Program]

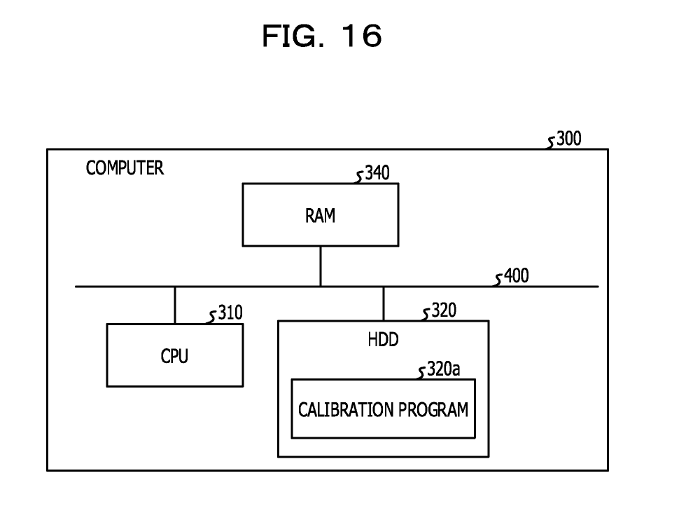

Furthermore, it is also possible to implement the various kinds of processing described in the above embodiment examples by executing a program prepared in advance by a computer system such as a personal computer or a work station. Therefore, in the following, one example of a computer system that executes a program including functions similar to those in the above embodiment examples will be described. FIG. 16 is a diagram illustrating a computer that executes a calibration program.

As illustrated in FIG. 16, a computer 300 that implements functions of the base station 11 includes a CPU 310, a hard disk drive (HDD) 320, and a RAM 340. These respective units 300 to 340 are coupled via a bus 400.

In the HDD 320, a calibration program 320a that exerts functions similar to those of the above-described setting unit 40, transmission/reception control unit 41, estimating unit 42, acquiring unit 43, notifying unit 44, and calculating unit 45 is stored in advance. The calibration program 320a may be divided as appropriate.

Furthermore, the HDD 320 stores various kinds of information. For example, the HDD 320 stores various kinds of data used for an operating system (OS) and production planning.

Moreover, the CPU 310 carries out operations similar to those of the respective processing units of the embodiment examples by reading out the calibration program 320a from the HDD 320 and executing the calibration program 320a. That is, the calibration program 320a carries out operations similar to those of the setting unit 40, the transmission/reception control unit 41, the estimating unit 42, the acquiring unit 43, the notifying unit 44, and the calculating unit 45.

The above-described calibration program 320a does not necessarily need to be originally stored in the HDD 320.

For example, programs are stored in advance in “portable physical medium” such as flexible disc (FD), compact disc read only memory (CD-ROM), digital versatile disc (DVD), magneto-optical disc, and integrated circuit (IC) card inserted into the computer 300. Then, the computer 300 may read out the programs from these media to execute the programs.

Moreover, programs are stored in advance in “other computers (or servers)” coupled to the computer 300 via public line, the Internet, local area network (LAN), wide area network (WAN), etc. Then, the computer 300 may read out the programs from these computers to execute the programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a memory; and
a processor coupled to the memory and configured to:
transmit a radio signal using a plurality of antennas in a first period for transmission of the base station in a time division duplex (TDD) mode, at least a part of the first period overlapping with at least a part of a second period for reception of another base station in the TDD mode,
receive a specific information from the another base station, the first information indicating a channel characteristic from the base station to the another base station, the channel characteristic being estimated in accordance with the transmitted radio signal, and
determine at least one correction coefficient to compensate for a difference of specific characteristics among the plurality of antennas based on the received specific information.

2. The base station according to claim 1, wherein
the base station performs a wireless communication based on a first TDD configuration indicating first uplink periods for uplink communication and a first downlink periods for downlink communication,
the another base station performs a wireless communication based on a second TDD configuration indicating second uplink periods for uplink communication and a second downlink periods for downlink communication, and
at least one of the first downlink periods overlaps with at least one of the second uplink periods.

3. The base station according to claim 1, wherein
the base station performs a wireless communication based on a first TDD configuration indicating first uplink periods for uplink communication, a first downlink periods for downlink communication, and first switching periods for switching between uplink communication and downlink communication,
the another base station performs a wireless communication based on a second TDD configuration indicating second uplink periods for uplink communication and a second downlink periods for downlink communication, and
at least one of the first switching periods overlaps with at least one of the second uplink periods.

4. The base station according to claim 1, wherein
the base station performs a wireless communication based on a first TDD configuration indicating first uplink periods for uplink communication, and a first downlink periods for downlink communication,
the another base station performs a wireless communication based on a second TDD configuration indicating second uplink periods for uplink communication, a second downlink periods for downlink communication, and second switching periods for switching between uplink communication and downlink communication, and
at least one of the first downlink periods overlaps with at least one of the second switching periods.

5. The base station according to claim 1, wherein
a transmission power of the transmitted radio signal in the first period is higher than a transmission power of a radio signal transmitted in other than the first period.

6. The base station according to claim 1, wherein
the first period is a downlink subframe, and the second period is a uplink subframe.

7. The base station according to claim 1, wherein
the difference of the specific characteristics among the plurality of antennas includes a difference of phase among the plurality of antennas.

8. The base station according to claim 1, wherein
the processor is configured to:
receive a radio signal using a plurality of antennas in a third period for reception of the base station, at least a part of the third period overlapping with at least a part of a fourth period for transmission of the another base station,
estimate another channel characteristic from the another base station to the base station in accordance with the received radio signal, and
determine the at least one correction coefficient further based on the estimated channel characteristic.

9. A base station comprising:
a memory; and
a processor coupled to the memory and configured to:
receive a radio signal using a plurality of antennas in a first period for reception of the base station in a time division duplex (TDD) mode, at least a part of the first period overlapping with at least a part of a second period for transmission of another base station in the TDD mode,
estimate a channel characteristic from the another base station to the base station in accordance with the received radio signal, and
determine at least one correction coefficient to compensate for a difference of specific characteristics among the plurality of antennas based on the estimated channel characteristic.

10. The base station according to claim 9, wherein
the base station performs a wireless communication based on a first TDD configuration indicating first uplink periods for uplink communication and a first downlink periods for downlink communication,
the another base station performs a wireless communication based on a second TDD configuration indicating second uplink periods for uplink communication and a second downlink periods for downlink communication, and
at least one of the first uplink periods overlaps with at least one of the second downlink periods.

11. The base station according to claim 9, wherein
the base station performs a wireless communication based on a first TDD configuration indicating first uplink periods for uplink communication, a first downlink periods for downlink communication, and first switching periods for switching between uplink communication and downlink communication,
the another base station performs a wireless communication based on a second TDD configuration indicating second uplink periods for uplink communication and a second downlink periods for downlink communication, and
at least one of the first switching periods overlaps with at least one of the second downlink periods.

12. The base station according to claim 9, wherein
the base station performs a wireless communication based on a first TDD configuration indicating first uplink periods for uplink communication, and a first downlink periods for downlink communication,
the another base station performs a wireless communication based on a second TDD configuration indicating second uplink periods for uplink communication, a second downlink periods for downlink communication, and second switching periods for switching between uplink communication and downlink communication, and
at least one of the first uplink periods overlaps with at least one of the second switching periods.

13. The base station according to claim 9, wherein
the processor is configured to control terminals so that the terminals stop transmissions in the first period.

14. The base station according to claim 9, wherein
the first period is a uplink subframe, and the second period is a downlink subframe.

15. The base station according to claim 9, wherein
the difference of the specific characteristics among the plurality of antennas includes a difference of phase among the plurality of antennas.

16. A terminal comprising:
a memory; and
a processor coupled to the memory and configured to:
transmit a radio signal using a plurality of antennas in a first period for transmission of the terminal in a time division duplex (TDD) mode, at least a part of the first period overlapping with at least a part of a second period for reception of another terminal in the TDD mode,
receive a specific information from the another terminal, the first information indicating a channel characteristic from the terminal to the another terminal, the channel characteristic being estimated in accordance with the transmitted radio signal, and
determine at least one correction coefficient to compensate for a difference of specific characteristics among the plurality of antennas based on the received specific information.

17. The terminal according to claim 16, wherein
the processor is configured to:
receive a radio signal using a plurality of antennas in a third period for reception of the terminal, at least a part of the third period overlapping with at least a part of a fourth period for transmission of the another terminal,
estimate another channel characteristic from the another terminal to the terminal in accordance with the received radio signal, and
determine the at least one correction coefficient further based on the estimated channel characteristic.
